(19) United States
(12) Patent Application Publication
(10) Pub. No.: US 2014/0359359 A1
(43) Pub. Date: Dec. 4, 2014

(54) TESTING DEVICE AND TESTING METHOD FOR TESTING NETWORK FUNCTION OF TO-BE-TESTED DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: XIAO-LI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/063,174

(22) Filed: Oct. 25, 2013

(30) Foreign Application Priority Data
May 30, 2013 (CN) 2013102094117

(51) Int. Cl. G06F 11/273

(52) U.S. Cl. CPC G06F 11/2733
USPC 714/27

(57) ABSTRACT

A testing device communicates with an external device. The external device establishes a local area network for providing private internet protocol address. The testing device includes an obtaining module, a first determining module, a testing module, and a prompting module. The obtaining module obtains a count of feature information of the external device at a time interval. The first determining module controls the testing module to generate a testing instruction when the obtained count is more than a predetermined value. The prompting module generates different prompting information based on the received feedback information to indicate the state of network function of the to-be-tested device. A testing method is also provided.

### BACKGROUND

1. Technical Field

The present disclosure relates to a testing device and a testing method for testing network function of a to-be-tested device.

2. Description of Related Art

Generally, when an external computer tests an electronic device for network functionality, the IP address of the electronic device in the local area network (LAN), formed by the external computer and the electronic device, is entered manually and the testing instruction is manually inputted a number of times, which is complicated and time consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of a testing device communicating with a to-be-tested device and an external device in accordance with an embodiment.

FIG. 2 is a chart showing a visual interface of the electronic device of FIG. 1 in accordance with an embodiment.

FIG. 3 is a flowchart of a testing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

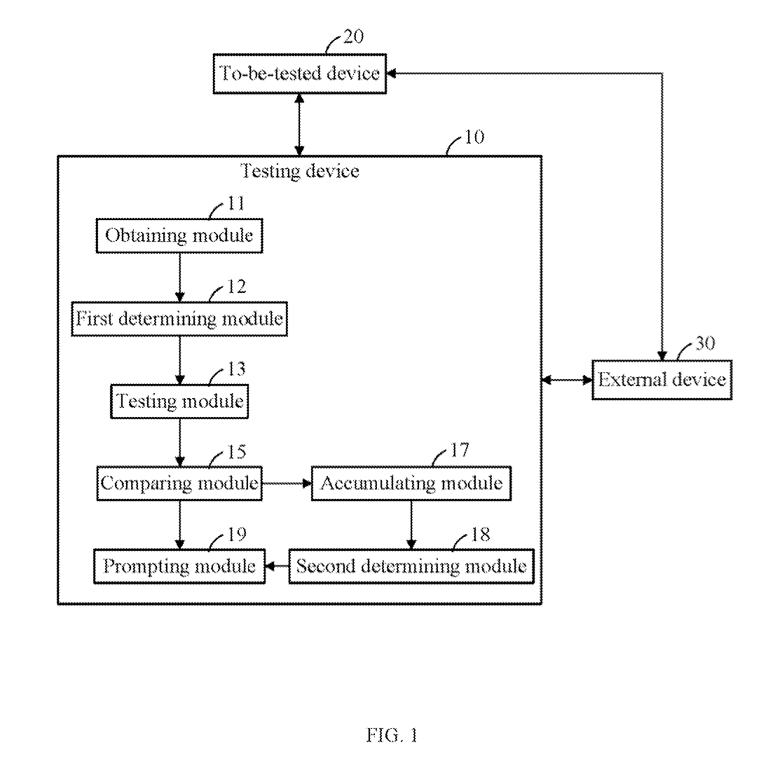

FIG. 1 shows a testing device 10 of one embodiment of the present disclosure. The testing device 10 communicates with an external device 30 which establishes a local area network (LAN) for providing private internet protocol (IP) address. The testing device 10 automatically tests a network function of a to-be-tested device 20 when the to-be-tested device 20 enters the LAN. In the embodiment, the testing device 10 is a computer, the to-be-tested device 20 is a mobile phone, and the external device 30 is a router; the testing device 10 and the to-be-tested device 20 connect with the external device 30 wirelessly. In other embodiments, the testing device 10 and the to-be-tested device 20 connect with the external device 30 with wires.

The testing device 10 includes an obtaining module 11, a first determining module 12, a testing module 13, a comparing module 15, an accumulating module 17, a second determining module 18, and a prompting module 19.

The obtaining module 11 obtains a count of feature information from the external device 30 at a predetermined time interval. In the embodiment, the feature information is a private internet protocol (IP) address ranging from 10.0.0.0 to 10.255.255.255 in binary number, and the time interval is adjustable.

The first determining module 12 determines whether the obtained count is more than a first predetermined value. When the obtained count is more than the first predetermined value, the to-be-tested device 20 accesses the LAN and the first determining module 12 extracts the feature information relating to the to-be-tested device 20 and generates a testing signal. In the embodiment, the first predetermined value is 2.

The testing module 13 generates a testing instruction for controlling the to-be-tested device 20 to execute the testing instruction in response to the testing signal, and receives feedback information from the to-be-tested device 20 after the to-be-tested device 20 executes the testing instruction. In the embodiment, the testing instruction is formatted in a predetermined internet control message protocol (ICMP) package; the testing instruction includes a “ping” character string and the IP address of the to-be-tested device 20, the feedback information includes a response time, response content, and a time to live (TTL).

The comparing module 15 compares the received feedback information with standard information. When the received feedback information matches the standard information, the comparing module 15 generates a control signal to indicate that a network function of the to-be-tested device 20 is successful one time. When the received feedback information does not match the standard information, the comparing module 15 generates a first prompting signal to indicate that the network function of the to-be-tested device 20 has failed.

The accumulating module 17 accumulates the number of success times and generates a first determining signal in response to the control signal. Each of the success times indicates that the network function of the to-be-tested device 20 is successful.

The second determining module 18 determines whether the number of the success times exceeds a second predetermined value in response to the first determining signal. When the number of the success times exceeds the second predetermined value, the second determining module 18 generates a second prompting signal. When the number of the success times does not exceed the second predetermined value, the second determining module 18 generates a testing signal. In the embodiment, the second predetermined value can be manually set.

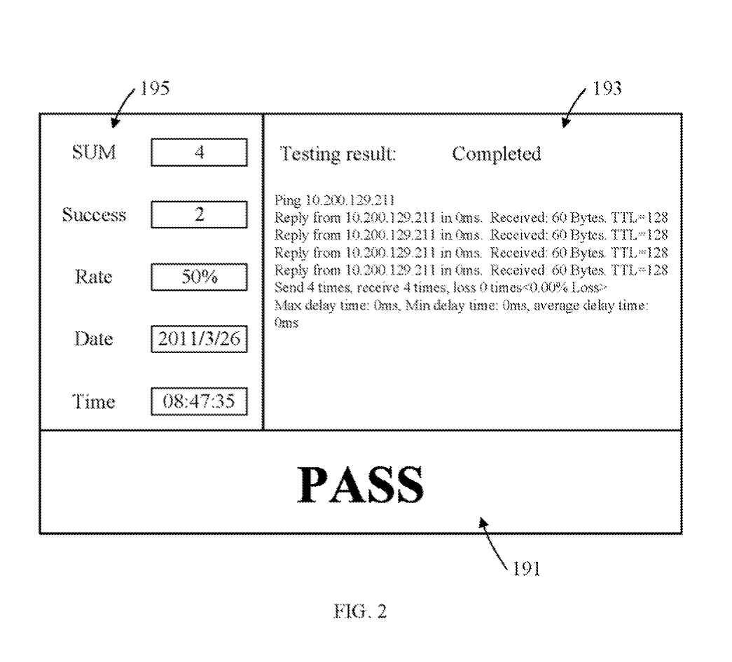

The prompting module 19 outputs first prompting information for indicating that the network function of the to-be-tested device 20 is in a normal state in response to the first prompting signal, and outputs second prompting information for indicating that the network function of the to-be-tested device 20 is in an abnormal state in response to the second prompting signal. The prompting module 19 forms a visual interface 19 (as FIG. 2 shown) for displaying the prompting information. As shown in FIG. 2, the visual interface 19 includes a first region 191, a second region 193, and a third region 195. The first region 191 displays the first prompting information or the second prompting information. The second region 193 displays the testing instruction and the received feedback information. The third region 195 displays related information. In the embodiment, the related information includes a sum of the to-be-tested device 20, a sum of the to-be-tested device 20 in the normal state, a percent of the to-be-tested device 20 in the normal state, a current data information, and a current time information; the first prompting information is a term “FAIL” and the second prompting information is a term “PASS”. In the other embodiments, the first and second prompting information can be video signal, audio signal, or text information for example.

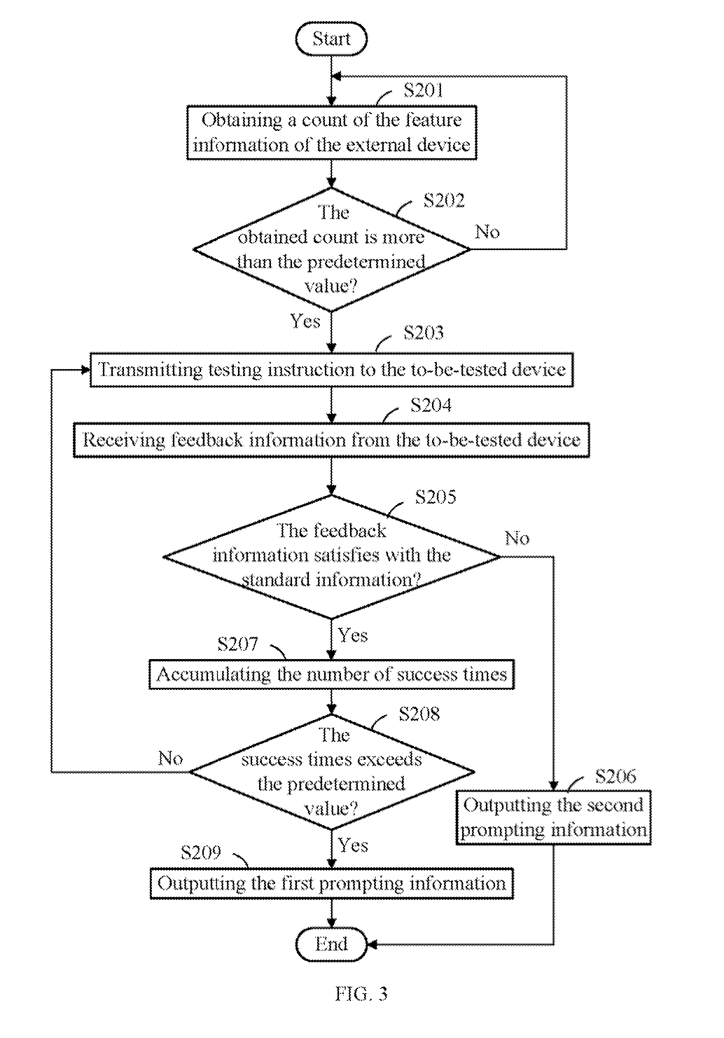

FIG. 3 shows a testing method applied to a testing device 10 communicated with an external device 30 for automatically testing network function of a to-be-tested device 20. The external device 30 establishes a local area network (LAN) for providing private internet protocol (IP) address. In the embodiment, the testing device 10 is a computer, the to-be-tested device 20 is a mobile phone, and the external device 30 is a router; the testing device 10 and the to-be-tested device 20 connects with the external device 30 wirelessly. In other embodiments, the testing device 10 and the to-be-tested device 20 connects with the external device 30 via wires. The testing method includes the following steps.

In step S201, the obtaining module 11 obtains a count of feature information from the external device 30 at a predetermined time interval. In the embodiment, the feature information is a private internet protocol (IP) address ranging from 10.0.0.0 to 10.255.255.255 in binary number, and the time interval is adjustable.

In step S202, the first determining module 12 determines whether the obtained count is more than a predetermined value. If the obtained count is more than the predetermined value, a testing signal is generated for indicating that the to-be-tested device 20 accesses the LAN and the procedure goes to S203. If the obtained count is no more than the predetermined value, the procedure returns to S201.

In step S203, in response to the testing signal the testing module 13 generates a testing instruction for controlling the to-be-tested device 20 to execute the testing instruction. In the embodiment, the testing instruction is formatted in a predetermined internet control message protocol (ICMP) package; the testing instruction includes a “ping” character string and the IP address of the to-be-tested device 20.

In step S204, the testing module 13 further receives feedback information from the to-be-tested device 20 after the to-be-tested device 20 executes the testing instruction. In the embodiment, the feedback information includes a response time, response content, and a time to live (TTL).

In step S205, the comparing module 15 compares the received feedback information with standard information. If the feedback information matches the standard information, a first control signal is generated for indicating that the network function of the to-be-tested device 20 is successful one time and the procedure goes to S207. When the feedback information does not match the standard information, a first prompting signal is generated and the procedure goes to S206.

In step S206, in response to the first prompting signal the prompting module 19 outputs first prompting information for indicating that the network function of the to-be-tested device 20 has failed. In the embodiment, the first prompting information is a term “FAIL”. In the other embodiment, the first prompting information can be video signal, audio signal, or text information for example.

In step 207, in response to the first control signal the accumulating module 17 accumulates a number of success times and generates a determining signal.

In step S208, in response to the determining signal the second determining module 18 determines whether the number of the success times exceeds a second predetermined value. If the number of the success times exceeds the second predetermined value, a first prompting signal is generated and the procedure goes to S209; if the number of the success times does not exceed the second predetermined value, the testing signal is generated and the procedure goes to S203.

In step S209, in response to the second prompting signal the prompting module 16 outputs second prompting information for indicating that the network function of the to-be-tested device 20 is in a normal state. In the embodiment, the second prompting information is a term “PASS”. In the other embodiment, the second prompting information can be video signal, audio signal, or text information for example.

In use, the testing device 10 automatically generates testing instruction and tests the network function of the to-be-tested device 20 repeatedly. Therefore, the testing operation is improved.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A testing device communicating with an external device, the external device capable of establishing a local area network for providing private internet protocol (IP) address; the testing device comprising:
an obtaining module for obtaining feature information from the external device at a predetermined time interval;
a first determining module for determining whether the obtained count of the obtained feature information is more than a first predetermined value;
a testing module for generating a testing instruction to the to-be-tested device when the obtained count is more than the first predetermined value, and receiving feedback information which is generated by the external device after the to-be-tested device executes the testing instruction; and
a prompting module for generating different prompting information, indicating whether the network function of the to-be-tested device is in a normal state, based on the received feedback information.

2. The testing device of claim 1, further comprising a comparing module, wherein the comparing module determines whether the feedback information matches a standard information, when the feedback information does not match the standard information, the comparing module controls the prompting module to generate first prompting information for indicating that the network function of the to-be-tested device is in an abnormal state.

3. The testing device of claim 2, further comprising an accumulating module and a second determining module, wherein the second determining module comprises a second predetermined value; when the feedback information matches the standard information, the comparing module controls the accumulating module to accumulate a number of success times; the second determining module determines whether the number of the success times exceeds the second predetermined value, when the number of the success times exceeds the second predetermined value, the second determining module controls the prompting module generate second prompting information for indicating that the network function of the to-be-tested device is in a normal state.

4. The testing device of claim 3, wherein the second predetermined value can be manually set.

5. The testing device of claim 1, wherein the time interval can be manually set.

6. The testing device of claim 1, wherein the testing instruction is formatted in a predetermined internet control message protocol package; the testing instruction includes a “ping” character string and the IP address of the to-be-tested device.

7. The testing device of claim 1, wherein the feedback information includes a response time, response content, and a time to live.

8. The testing device of claim 1, wherein the prompting module forms a visual interface; the visual interface comprises a first region for displaying the different prompting information.

9. The testing device of claim 8, wherein the visual interface further comprises a second region; the second region displays the testing instruction and the received feedback information.

10. A testing method for a testing device communicated with an external device which establishes a local area network for providing private internet protocol address, the testing method comprising:
obtaining a count of feature information of the external device at a time interval;
determining whether the obtained count is more than a first predetermined value;
generating a testing instruction to the to-be-tested device when the obtained count is more than the first predetermined value;
receiving feedback information which is generated by the to-be-tested after the to-be-tested device executes the testing instruction; and
generating different prompting information, indicating whether the network function of the to-be-tested device is in a normal state, based on the received feedback information.

11. The method of claim 10, wherein the testing device comprises a standard information; before the step of prompting different prompting information based on the received feedback information further comprising:
comparing whether the feedback information matches the standard information; and
generating first prompting information when the feedback information does not match the standard information for indicating that the network function of the to-be-tested device is in an abnormal state.

12. The method of claim 11, wherein the testing device further comprises a second predetermined value, the step of comparing whether the feedback information matches the standard information further comprising:
accumulating a number of success times when the feedback information matches standard information;
determining whether the number of the success times exceeds the second predetermined value; and
generating second prompting information when the number of the success times exceeds the second predetermined value for indicating that the network function of the to-be-tested device is in a normal state.

13. The method of claim 12, wherein the second predetermine value can be manually set.

14. The method of claim 10, wherein the time interval can be manually set.

15. The method of claim 10, wherein the testing instruction is formatted in a predetermined internet control message protocol package; the testing instruction includes a “ping” character string and the IP address of the to-be-tested device.

16. The method of claim 10, wherein the feedback information includes a response time, response content, and a time to live.
